(19) United States
(12) Patent Application Publication
(10) Pub. No.: US 2019/0197640 A1
(43) Pub. Date: Jun. 27, 2019

(54) FLOCK-BASED CROWD MOVEMENT ANALYSIS FOR PREDICTIVE CONFLICT IDENTIFICATION IN A SAFETY RESPONSE SYSTEM

(71) Applicant: International Business Machines Corporation, Armonk, NY (US)

(72) Inventors: Ben Z. Akselrod, Gir'at Shmuel (IL); Anthony Di Loreto, Markham (CA); Steve McDuff, Markham (CA); Kyle D. Robeson, North York (CA)

(21) Appl. No.: 15/849,884

(22) Filed: Dec. 21, 2017

(51) Int. Cl. G06Q 50/26; G06F 7/02

(52) U.S. Cl. CPC G06Q 50/265; G06N 7/005; G06F 7/02

(57) ABSTRACT

Approaches presented herein enable predictive conflict identification in a safety response system. More specifically, a likely intersection location of two or more flocks of people is determined based on predicted travel vectors of the flocks. Information about attributes of the people in each of the flocks is obtained to determine whether a potential conflict exists between the intersecting flocks. These flock attributes are analyzed, with attributes indicative of a potential conflict between the flocks being assigned a greater weight than attributes not indicative of a potential conflict. Based on the analysis, a conflict factor score is assigned to the intersection of the flocks. A security authority is then selectively informed by a generated notification, in the case that it is determined that the conflict factor meets or exceeds a predetermined security threshold, of the predicted intersection of the flocks.

### TECHNICAL FIELD

The present invention relates generally to predictive conflict identification in a safety response system and, more specifically, to a safety response system that determines a potential conflict between two or more groups intersecting at a physical location and evaluates a risk of conflict between the groups based on attributes of the groups.

### BACKGROUND

When groups of people with different interests or preferences crowd in or around public places, such as sports stadiums, entertainment or recreation venues, parks, or street corners, tensions can run high between these groups. In some instances, these meetings can devolve into aggression, violence, or other situations dangerous to members of the groups, as well as to bystanders. Such dangerous situations can escalate quickly, drawing many members of both groups into a conflict or other undesirable or dangerous incident. Although peace officers, such as public or private security officers, attempt to diffuse dangerous situations and maintain civil peace, the peace officers can become quickly overwhelmed if a dangerous situation escalates beyond their ability to respond. Peace officers may find that they are spread too thinly for an effective response or that they simply arrived too late at a scene, after the situation has already escalated. Although peace officer organizations attempt to deploy officers to areas where altercations are thought most likely to occur or to areas where the officers will have the best vantage points to monitor a crowd, peace officers often have difficulty predicting whether a situation might escalate and responding in time to prevent this from occurring.

### SUMMARY

Approaches presented herein enable predictive conflict identification in a safety response system. More specifically, a likely intersection location of two or more flocks of people is determined based on predicted travel vectors of the flocks. Information about attributes of the people in each of the flocks is obtained to determine whether a potential conflict exists between the intersecting flocks. These flock attributes are analyzed, with attributes indicative of a potential conflict between the flocks being assigned a greater weight than attributes not indicative of a potential conflict. Based on the analysis, a conflict factor score is assigned to the intersection of the flocks. A security authority is then selectively informed by a generated notification, in the case that it is determined that the conflict factor meets or exceeds a predetermined security threshold, of the predicted intersection of the flocks.

One aspect of the present invention includes a method for predictive conflict identification in a safety response system, comprising: determining, based on a predicted travel vector of a first flock and a predicted travel vector of a second flock, an intersection location of the first flock and the second flock; obtaining attribute information associated with people of the first flock and people of the second flock; analyzing the obtained attribute information to determine a conflict factor between the first flock and the second flock; determining whether the conflict factor exceeds a predetermined security threshold; and selectively generating, responsive to a determination that the conflict factor exceeds the predetermined security threshold, a notification.

Another aspect of the present invention includes a safety response computer system for predictive conflict identification, the computer system comprising: a memory medium comprising program instructions; a bus coupled to the memory medium; and a processor, for executing the program instructions, coupled to a predictive security response engine via the bus that when executing the program instructions causes the system to: determine, based on a predicted travel vector of a first flock and a predicted travel vector of a second flock, an intersection location of the first flock and the second flock; obtain attribute information associated with people of the first flock and people of the second flock; analyze the obtained attribute information to determine a conflict factor between the first flock and the second flock; determine whether the conflict factor exceeds a predetermined security threshold; and selectively generate, responsive to a determination that the conflict factor exceeds the predetermined security threshold, a notification.

Yet another aspect of the present invention includes a computer program product for predictive conflict identification in a safety response system, the computer program product comprising a computer readable hardware storage device, and program instructions stored on the computer readable hardware storage device, to: determine, based on a predicted travel vector of a first flock and a predictive travel vector of a second block, an intersection location of the first flock and the second flock; obtain attribute information associated with people of the first flock and people of the second flock; analyze the obtained attribute information to determine a conflict factor between the first flock and the second flock; determine whether the conflict factor exceeds a predetermined security threshold; and selectively generate, responsive to a determination that the conflict factor exceeds the predetermined security threshold, a notification.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 shows an architecture in which the invention may be implemented according to illustrative embodiments;

FIG. 2 shows a more detailed system architecture for predictive conflict identification in a safety response system according to illustrative embodiments;

FIG. 3 shows an illustrative example of predictive conflict identification in a safety response system according to illustrative embodiments;

FIG. 4 shows determination of a conflict factor between two flocks that are likely to intersect according to illustrative embodiments; and

FIG. 5 shows a process flowchart for predictive conflict identification in a safety response system according to illustrative embodiments.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Unless specifically stated otherwise, it may be appreciated that terms such as “processing,” “detecting,” “determining,” “evaluating,” “receiving,” or the like, refer to the action and/or processes of a computer or computing system, or similar electronic data center device, that manipulates and/or transforms data represented as physical quantities (e.g., electronic) within the computing system's registers and/or memories into other data similarly represented as physical quantities within the computing system's memories, registers or other such information storage, transmission or viewing devices. The embodiments are not limited in this context.

As stated above, embodiments described herein provide for predictive conflict identification in a safety response system. More specifically, a likely intersection location of two or more flocks of people is determined based on predicted travel vectors of the flocks. Information about attributes of the people in each of the flocks is obtained to determine whether a potential conflict exists between the intersecting flocks. These flock attributes are analyzed, with attributes indicative of a potential conflict between the flocks being assigned a greater weight than attributes not indicative of a potential conflict. Based on the analysis, a conflict factor score is assigned to the intersection of the flocks. A security authority is then selectively informed by a generated notification, in the case that it is determined that the conflict factor meets or exceeds a predetermined security threshold, of the predicted intersection of the flocks.

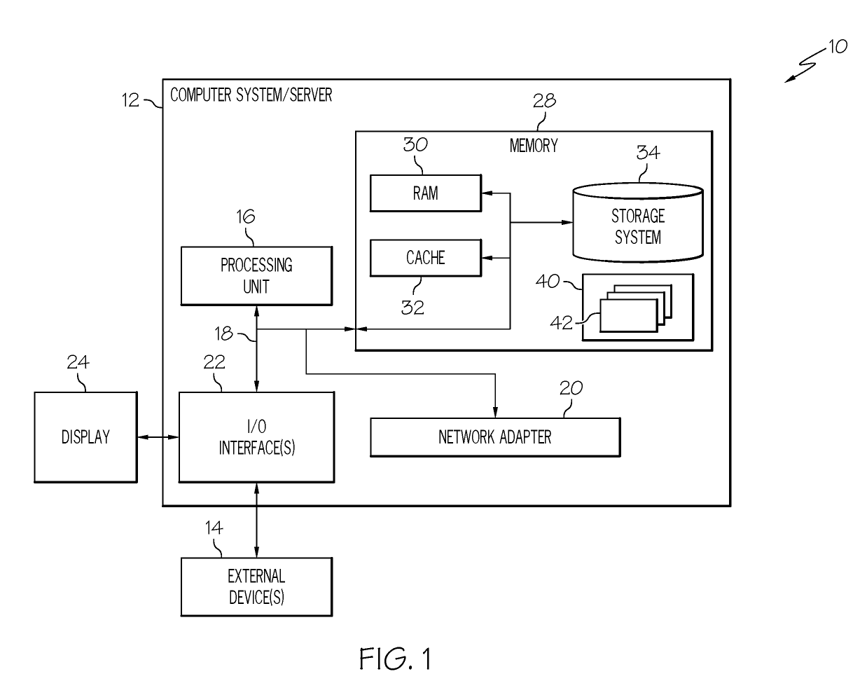

Referring now to FIG. 1, a computerized implementation 10 of an embodiment of the present invention will be shown and described. Computerized implementation 10 is only one example of a suitable implementation and is not intended to suggest any limitation as to the scope of use or functionality of embodiments of the invention described herein. Regardless, computerized implementation 10 is capable of being implemented and/or performing any of the functionality set forth hereinabove.

In computerized implementation 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and/or the like.

This is intended to demonstrate, among other things, that the present invention could be implemented within a network environment (e.g., the Internet, a wide area network (WAN), a local area network (LAN), a virtual private network (VPN), etc.), a cloud computing environment, a cellular network, or on a stand-alone computer system. Communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer system/server 12 is intended to demonstrate that some or all of the components of implementation 10 could be deployed, managed, serviced, etc., by a service provider who offers to implement, deploy, and/or perform the functions of the present invention for others.

Computer system/server 12 is intended to represent any type of computer system that may be implemented in deploying/realizing the teachings recited herein. Computer system/server 12 may be described in the general context of computer system/server executable instructions, such as program modules, being executed by a computer system. Generally, program modules may include routines, programs, objects, components, logic, data structures, and so on, that perform particular tasks or implement particular abstract data types. In this particular example, computer system/server 12 represents an illustrative system for carrying out embodiments of the present invention. It should be understood that any other computers implemented under the present invention may have different components/software, but can perform similar functions.

Computer system/server 12 in computerized implementation 10 is shown in the form of a general-purpose computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Processing unit 16 refers, generally, to any apparatus that performs logic operations, computational tasks, control functions, etc. A processor may include one or more subsystems, components, and/or other processors. A processor will typically include various logic components that operate using a clock signal to latch data, advance logic states, synchronize computations and logic operations, and/or provide other timing functions. During operation, processing unit 16 collects and routes signals representing inputs and outputs between external devices 14 and input devices (not shown). The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different systems may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 16 executes computer program code, such as program code for carrying out embodiments of the present invention, which is stored in memory 28, storage system 34, and/or program/utility 40. While executing computer program code, processing unit 16 can read and/or write data to/from memory 28, storage system 34, and program/utility 40.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media, (e.g., VCRs, DVRs, RAID arrays, USB hard drives, optical disk recorders, flash storage devices, and/or any other data processing and storage elements for storing and/or processing data). By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The inventors of the present invention have found that peace officers or other security personnel may be dispatched too late to maintain civil peace when an intersection of two or more groups of people leads to an escalating confrontation. For instance, if a group of fans of a sports team meet a group of fans of an opponent sports team, there may be a verbal or physical altercation, particularly if the two teams have recently competed against one another or will do so in the near future. Unfortunately, peace officers and security personnel are sometimes not deployed to a scene until after it becomes evident that a conflict is taking place. Therefore, the peace officers or security personnel cannot begin to initiate a response until the conflict actually begins, needing to first observe a conflict indicator, such as, for example, the exchange of words or gestures. By this time, it may be too late for peace officers or security personnel to arrive at a scene, take position, and act to stop further escalation. In the time needed to observe the occurring conflict and respond to it, both active participants in the conflict as well as bystanders may be injured.

Accordingly, the inventors of the present invention have developed an improved safety response system that permits potential conflicts between groups of people to be predicted and, therefore, peaceably prevented. More specifically, the system developed by the inventors of the present invention uses people segmentation, location tracking, and travelling pattern analysis to detect people who share some attributes and group them as a flock. The system then predicts the movement of the flock and identifies when and where intersections of two or more flocks are likely to occur. The system further determines (e.g., based on parameters and thresholds) if there is a likelihood of conflict between the flocks and, if so, enhances existing safety response systems by notifying peace officers or other security personnel of the likely conflict intersection before it has occurred.

Furthermore, embodiments of the present invention offer several advantages over previous solutions for maintaining civil peace. The predictive feature of embodiments of the present invention enhances the effectiveness of current safety, security, and surveillance systems by enabling these systems to analyze a crowd of people and assess a risk of conflict involving that crowd. This permits current safety, security, and surveillance systems to issue safety and security alerts more promptly, providing responders with an increased response time window. Furthermore, this permits current safety, security, and surveillance systems to prioritize safety and security issues and allot resources to respond to those issues having the greatest priority. Further, such enhanced safety, security, and surveillance systems permit a dispatcher to deploy peace officers or security personnel to where they will be most imminently needed, as opposed to merely where they are currently needed. In another example, such enhanced systems permit a dispatcher to rank of which situations are most in need of the presence of peace officers or security personnel and therefore give priority to those situations. It should also be understood that the predictive response of embodiments of the present invention offers additional security and safety over previous solutions by preempting and thereby preventing confrontations and resulting injuries.

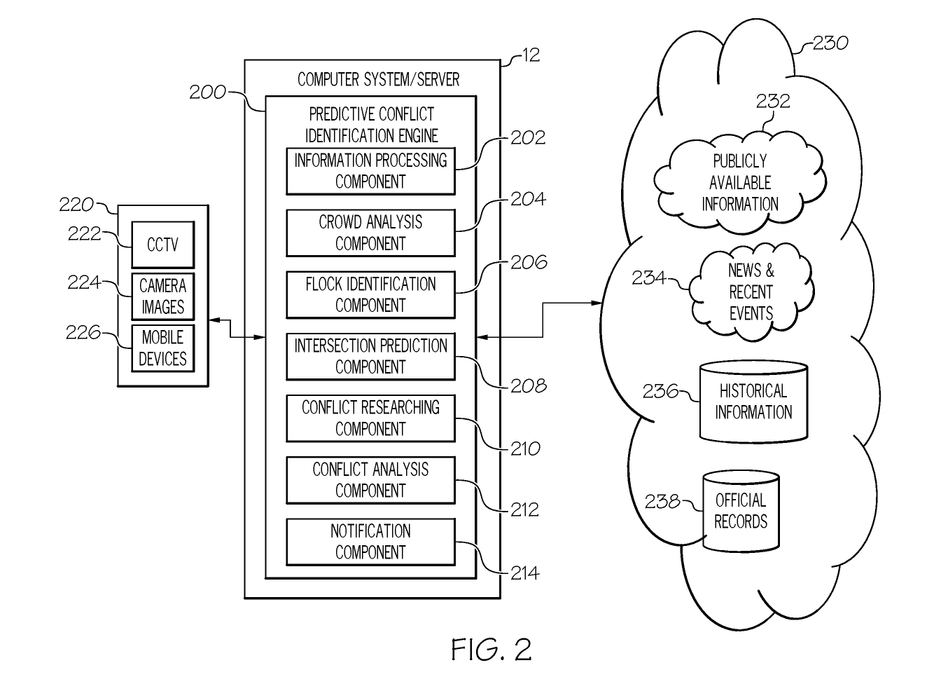

Referring now to FIG. 2, a more detailed system architecture for predictive conflict identification in a safety response system according to illustrative embodiments is shown. Computer system/server 12 (FIG. 1) can include predictive conflict identification engine 200 (hereinafter system 200) for performing embodiments of the present invention. It should be understood that, although system 200 is presented in illustrative embodiments of the present invention discussed herein as residing on computer system/server 12, in some embodiments, system 200 can reside on any type of device, computer system, server, virtual server, cloud computing virtual machine, etc., capable of carrying out embodiments of the present invention.

In some embodiments, system 200 can be program/utility 40 of FIG. 1 and can contain a set of components (e.g., program modules 42 of FIG. 1) for carrying out embodiments of the present invention. These components can include, but are not limited to, information processing component 202, crowd analysis component 204, flock identification component 206, intersection prediction component 208, conflict researching component 210, conflict analysis component 212, and notification component 214.

Through computer system/server 12, system 200 can be in communication with people tracking information sources 220, such as CCTV feed 222, public camera images 224, and/or mobile device network information 226. Through computer system/server 12, system 200 can further be in communication with remote information 230. Remote information 230 can include publicly available information 232, such as information that may be found on the Internet, digital public records, digital public calendars (e.g., game day schedules, parade schedules or routes), social media, and/or the like. Additionally, or in the alternative, remote information 230 can include news stories and other recent event information 234, such as updates from a news website or information about an upcoming or recent sporting event. Additionally, or in the alternative, remote information 230 can include other information, such as from databases including historic records 236 and/or official records 238.

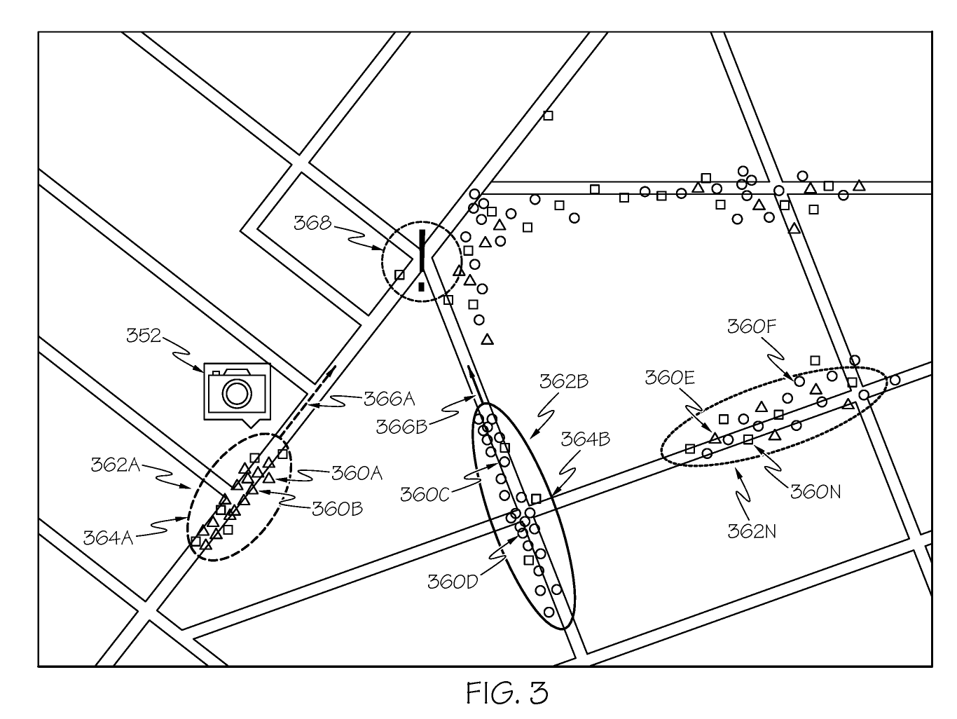

Referring now to FIG. 3 in connection with FIG. 2, an illustrative example of predictive conflict identification in a safety response system is shown. Information processing component 202 of system 200, as executed by computer system/server 12, can obtain information from people tracking information sources 220, such as security camera 352 in view of a crowd. Information processing component 202 organizes the obtained information for use by system 200. As briefly discussed above, this obtained information can include camera feeds and images from public security cameras. In some embodiments, information processing component 202 can correlate incoming information to determine a location and travel path of one or more persons or a crowd. Information processing component 202 may further contain image recognition capabilities to assist in determining a location and travel path of one or more persons 360A-N or crowds 362A-N. A travel path of crowd 362N can, in some embodiments, be determined by averaging a location and/or travel path of several persons 360A-N in crowd 362N. Further, image recognition, speech recognition, and/or text recognition abilities may be used to identify attributes of a crowd, such as several people wearing a certain sports team's memorabilia or carrying indicators, such as posters and signs, of affiliation with or support for a certain team.

Crowd analysis component 204 of system 200, as executed by computer system/server 12, can analyze a composition of a plurality of crowds of people using segmentation to determine shared attributes of a plurality of people in each crowd. To accomplish this, crowd analysis component can apply flock determination algorithms such as people segmentation (e.g., several people with a shared interest), location tracking (e.g., several people staying in the same area or close to one another), crowd density (e.g., people concentrated in a certain area), and travelling pattern analysis (e.g., several people moving in the same direction) to the information obtained and processed by information processing component 202. Additional information may be pulled from remote information 230 to further determine whether several people 360A-N in crowd 362A (or in crowd 362B or crowd 362N) share the same or similar interests. For example, crowd analysis component 204 may use facial recognition to identify a person in crowd 362N. Crowd analysis component 204 can use this identification to cross-reference the identified person in crowd 362A against remote information 230, such as publicly available information 232 corresponding to the person including, for example, a social media account or official records 238. From this information, crowd analysis component 204 can find people who share some attributes or interests and who may also, possibly, be part of a flock. For instance, because crowd 362A has 20 people walking in the same direction at a similar pace with a relatively high concentration of people per area, crowd analysis component 204 can analyze the composition of crowd 362A using segmentation to categorize members of crowd 362A into groups based on shared features. For instance, in this example, crowd analysis component 204 may determine the following attributes of crowd 362A: 75% of the people are fans of a specific sports team (e.g., The “Big State Triangles”), as indicated on social media; and 90% of them are male and 70% are in the 20-30 age group, as indicated by official records.

Flock identification component 206 of system 200, as executed by computer system/server 12, can identify, based on the shared attributes determined by crowd analysis component 204, a first flock and a second flock, each formed by a crowd of people, where the first flock primarily consists of people having a first shared attribute and the second flock primarily consists of people having a second shared attribute. Flock determination may, in some embodiments, be based on a segment of crowd 362A (or several closely related and/or overlapping segments of crowd 362A) reaching a predetermined threshold of a percent/fraction of the whole crowd 362A. For instance, continuing the example above, if a flock threshold is set at two-thirds shared interests, then, since over two-thirds of the people in crowd 362A are “Big State Triangles” fans, they are categorized as flock 364A. Likewise, because more people than the requisite threshold in crowd 362B are “North State Circles” fans, crowd 362B is identified as flock 364B. In some embodiments, this threshold may change based on a combination of features. For instance, a group of young people mostly in the 20-30 age group may have a lower requisite threshold than a group of older people mostly in the 70-80 age group.

It should be noted that a flock may be formed even if most of its participants do not know each other or at least do not appear to know one another. Furthermore, a flock can be any size, from two people to thousands. Therefore, even if there is little to no social media interconnection (e.g., shared friends) between members of crowd 362B, the crowd can still be designated as flock 364B. It may be the case that members of a flock may recognize they have shared interests (e.g., by wearing memorabilia from the same team), even if they have never met before or have no online social connections or other publicly known connections. It should also be understood that the shared interests used for flock identification can be based on shared features other than a team affiliation. Such shared features may include, for example, similar ages or age group, organizational affiliations, and/or any other interest or trait that two or more people share in common. In some instances, two or more of these factors may be combined to form a segment, such as young people who are fans of a specific sports team. It should also be understood that not all crowds are flocks. For example, persons 360E-N of crowd 362N do not have sufficient similarities across a wide enough segment of crowd 362N to be a flock. Instead, persons 360E-N have dissimilar interests and are too widely dispersed and intermixed within crowd 362N for any portion of the crowd to be a flock of similar interests.

Intersection prediction component 208 of system 200, as executed by computer system/server 12, can predict a travel vector of a first flock and of a second flock and determine, based on the predicted travel vectors, an intersection location of the first flock and the second flock. Intersection prediction component 208 uses the movement information gathered by information processing component 202 to project a location, a travel path, a speed, or a combination of the three—in other words, travel vectors 366A and 366B—of identified flocks 364A and 364B, respectively. For example, intersection prediction component 208 may determine that flock 364A is moving northeast at 2.5 miles per hour (mph), while flock 364B is moving northwest at 2.0 mph. In some embodiments, travel vectors 366A and 366B can be displayed on a map or other visual display for viewing by a user (e.g., a peace officer dispatcher) of system 200. Travel vectors 366A and 366B can be determined any of several ways, such as, but not limited to, averaging the location, direction/travel path, and speed of all members of flocks 364A and 364B, respectively. In other embodiments, travel vectors 366A and 366B can be measured based on the location, direction/travel path, and speed of one or more members of flocks 364A and 364B who are at the leading edge of flocks 364A and 364B. In this embodiment, the movements of the leading edge of flocks 364A and 364B, and the time at which or the time until those leading edges are predicted to collide, would be the focus of intersection prediction component 208.

When two or more flocks are relatively near one another (e.g., in the same town/city, in the same neighborhood), intersection prediction component 208 can compare flock travel vectors 366A and 366B to determine whether flocks 364A and 364B are likely to intersect. This comparison may leverage historical travel pattern records 236, such as those maintained by GPS mapping/navigation applications that monitor the locations of mobile devices of users of the GPS mapping/navigation application. Such information may be used to find travel paths and travel times most commonly taken by other historic GPS mapping/navigation application users having travel vectors similar to flock travel vectors 366A and 366B. In some embodiments, intersection prediction component 208 can use a calendar and known locations of events, for example retrieved from publically available information 232 or news and recent events 234, to search for intersections of groups associated with an event and/or location on the calendar. For instance, intersection prediction component 208 may find two flocks that are currently traveling along parallel routes, but are both heading towards an arena around game time, where the flocks may intersect. If, based on flock travel vectors 366A and 366B, intersection is likely, intersection prediction component 208 determines at what time and at what location this intersection is likely to take place.

For example, based on flock travel vectors 366A and 366B indicating that flock 364A is moving northeast at 4.5 mph and flock 364B is moving northwest at 4.0 mph, respectively, intersection prediction component 208 determines that flocks 364A and 364B are highly likely to intersect at predicted intersection location 368 in five minutes time. In some embodiments, intersection prediction component 208 may determine that there are several locations and/or times where flocks 364A and 364B might intersect (e.g., if flock 364A or 364B has multiple leading edges, like an amoeba, and periodically moves in the direction of each of those leading edges, as opposed to unidirectionally). In such a case, intersection prediction component 208 can return a ranked list of predicted intersection locations 368 and/or times according to likelihood.

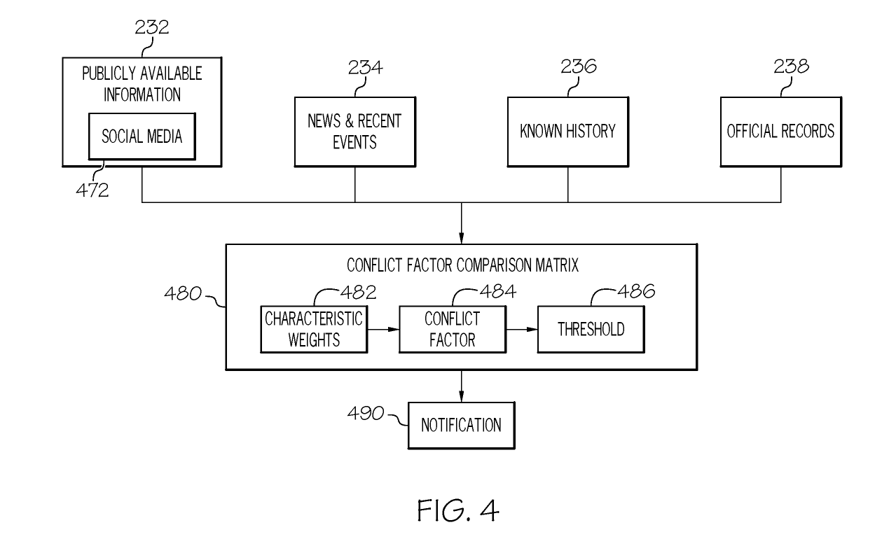

Referring now to FIG. 4 (in conjunction with FIGS. 2 and 3), determination of a conflict factor between two flocks that are likely to intersect is shown. In response to the identification of predicted intersection location 368 of two or more flocks 364A-B, conflict researching component 210 of system 200, as executed by computer system/server 12, gathers attribute information associated with the people of the two or more flocks to determine whether there is a potential conflict between the two or more flocks. This gathered information may include the attributes of segments of flocks 364A-B (i.e., crowds 362A-B) earlier identified by crowd analysis component 204. For example, conflict researching component 210 may note that 75% of the people in flock 364A are part of the “Big State Triangles” fans segment of flock 364A, while 89% of the people in flock 364B are part of the “North State Circles” fans segment of flock 364B. This gathered information may further include the location of predicted intersection location 368 relative to other places or geographic features in the same area. For example, conflict researching component 210 may note that predicted intersection location 368 is only a few yards from “North State Circles” Stadium.

Conflict researching component 210 can further search for information related to a potential conflict in remote information 230. This information related to a potential conflict may include news and recent events 234, such as current events related to the identified attributes of flocks 364A-B. For example, conflict researching component 210 may find that the “Big State Triangles” are playing the “North State Circles,” of which segments of flocks 364A and 364B are fans, respectively, later that day at “North State Circles” Stadium according to a public sports events calendar. Conflict researching component 210 may further look up previous events and known history 236 related to the identified attributes of flocks 364A-B. For example, conflict researching component 210 may discover that the “Big State Triangles” and the “North State Circles” have been competitors for years and that, on three occasions in the past decade, physical conflicts have broken out between “Big State Triangles” fans and “North State Circles” fans on game days near the stadiums in which the game in question was to be played.

In some embodiments, conflict researching component 210 may also use the facial recognition capabilities of crowd analysis component 204 to determine the identities of individuals in flock 364A and/or 364B. In other embodiments, conflict researching component 210 may use the identification obtained by crowd analysis component 204. In any case, once the identity of an individual is determined, conflict researching component 210 can find additional information about the person in remote information 230, such as publicly available information 232 on the person (e.g., social media 472 account).

In some embodiments, conflict researching component 210 can look for other aggravating factors that may increase the likelihood of an altercation between flocks 364A and 364B. Conflict researching component 210 can use the results of the image recognition performed by information processing component 202 to identify the presence of aggravating items or behaviors in flocks 364A or 364B. For instance, conflict researching component 210 can determine that several members of flock 364B are carrying items or performing actions that increase the likelihood of an altercation, such as carrying or drinking out of beverage containers.

Conflict analysis component 212 of system 200, as executed by computer system/server 12, analyzes the attribute information obtained by conflict researching component 210 to determine a conflict factor between two or more flocks and determines whether the conflict factor exceeds a predetermined security threshold. To accomplish this, conflict analysis component 212 inputs the information gathered by conflict researching component 210 into comparison matrix 480. In some embodiments, conflict analysis component 212 can organize the gathered information into sections or categories of characteristics/parameters within comparison matrix 480 for analysis. Each section or category of characteristics can be assigned characteristic severity weight 482 by conflict analysis component 212 depending on the severity of the information in that section/category. In some embodiments, conflict analysis component 212 can receive a set of thresholds, set by a user of system 200, which controls the severity of weight assigned to the severity of characteristic information. In other embodiments, conflict analysis component 212 can learn, based on historical data, which characteristics at which severity are most indicative of an altercation requiring a security or peace officer presence. Conflict analysis component 212 can then set the weight thresholds accordingly. In any case, conflict analysis component 212 can aggregate these weighted characteristics to yield conflict factor 484. Conflict factor 484 can be expressed several ways including, but not limited to, a hierarchical rating (e.g., high-medium-low) or a percentage (e.g., a scale between 0 and 100), etc. In some embodiments, conflict factor 484 is a probability of whether violence or an otherwise undesirable altercation will occur. This probability can be calculated, for example, by combining the weights of each characteristic to reach a total characteristics weight and then comparing this total characteristics weight to the maximum possible total weight (i.e., the combined weight of the maximum possible values/levels of all the characteristics) to get a fraction or percentage of total characteristics weight to total possible weight.

Continuing the illustrative example based on FIG. 3, conflict analysis component 212 may assign the following characteristics the following weights based on pre-set thresholds from a user of system 200:

| CHARACTERISTICS | THRESHOLD | WEIGHT |
|---|---|---|
| Intersection in 5 min. | Low, <5 min.; Medium, 5 to | Medium |
| | 15 min.; High, >15 min. | |
| 70% of flock 364A in | Low, <60% age 20-30; Medium, | Medium |
| 20-30 age group | 60-80% age 20-30; High, | |
| | >80% age 20-30 | |
| Fan base is 75% segment | Low, <70%; Medium, 70-90%; | Medium |
| of flock 364A and 89% | High, >90% | |
| segment of flock 364B | | |
| Each flock contains | Low, <20 people; Medium, | Medium |
| between 20 and 30 people | 20-40 people; High, >40 people | |
| Intersection 20 yd. from | Low, >half mile from any | High |
| North State Circles | hotspot; Medium, 200 yd. to half | |
| Stadium | mile from hotspot; High, within | |
| | 200 yd. of hotspot | |
| History of interaction | Low, amiable; Medium, neutral; | High |
| | High, unfriendly | |
| In past 10 yrs, 3 physical | Low, nonexistent; Medium, | High |
| conflicts near stadiums | verbal altercations; High, | |
| on game-day | physical altercations | |
| Circles vs. Triangles | Low, >a week; Medium, same | High |
| game in afternoon | week; High, same day | |

It should be understood that the above table is provided for illustrative purposes only and is not intended to be limiting. Conflict analysis component 212 can consider any type and number of characteristics in conflict factor comparison matrix 480. Such characteristics may include any item of information that may be pertinent to determining whether an intersection of a flock is likely to require a security response. Furthermore, although shown here as based on a three-tier hieratical rating, characteristic weights 482 may use any rating methodology or scale (e.g., numerical scale, a scale based on percentage, and/or the like). In any case, based on the above comparison, conflict analysis component 212 may determine that conflict factor 484 for intersection location 368 between flock 364A and flock 364B is high. By comparison, if flock 364A were to alternatively intersect a different flock, which primarily includes neutral “South State Quad” fans, at a similar time and location, conflict factor 484 for that alternative intersection would be low to medium because the “Big State Triangles” fans of flock 364A would not have the same potential conflict characteristics with a flock of fans of a neutral team.

Conflict analysis component 212 further determines if conflict factor 484 meets security issue threshold 486. In some embodiments, security issue threshold 486 may be set by a user of system 200. For example, conflict analysis component 212 can receive from the user security issue threshold 486 to be triggered in the event of a “high” conflict factor 484 or a conflict factor 484 above, for example, 75%. In still other embodiments, the setting of security issue threshold 486 may be automated based on historical data. For example, in some embodiments, conflict analysis component 212 can learn, based on historical data, at what conflict factor level a security or peace officer presence becomes needed. Conflict analysis component 212 can then set security issue threshold 486 accordingly.

If security issue threshold 486 is met or exceeded by conflict factor 484, notification component 214 of system 200, as executed by computer system/server 12, can generate (e.g., send, or instruct to be sent) a notification 490 to a user. In an embodiment, this user may be a dispatcher for a set of peace officers or other security officers. Additionally or in the alternative, the user may be a set of security or peace officers, or anyone else responsible for maintaining civil peace at a location. The kinds of flock intersections that result in generation of a security warning or notification can be controlled by a user through notification component 214, which can receive user-configured characteristic weights 482 and/or security issue threshold 486. In some embodiments, notification component 214 can be configured by the user to issue different kinds of notifications 490 depending on the conflict factor of the flock intersection. For example, notification component 214 can be configured to issue a moderate warning 490 when conflict factor 484 is medium and a severe waning 490 when conflict factor 484 is high.

In some embodiments, once notification 490 is generated, users, such as a dispatcher, may decide how to respond to the impending intersection 368 of flocks 364A and 364B. In other embodiments, notification component 214 can offer a response recommendation, along with notification 490, for best addressing intersection 368 of flocks 364A and 364B based on conflict factor 484 and other earlier identified characteristics of intersection 368. For instance, for a medium conflict factor intersection, notification component 214 may recommend that responding officers first attempt to talk with the intersecting flocks. On the other hand, in the case of a high conflict factor intersection, notification component 214 may recommend a more robust security response. In still further embodiments, notification component 214 can determine which parties are notified based on the severity of conflict factor 484. For example, notification component 214 may send a notification to a small private security team in response to a medium conflict factor 484, but send a notification to a larger, public peace officer organization in response to a high conflict factor 484.

In some embodiments, notification component 214 can provide a ranked list of notifications 490 for several different intersections between different flocks. This list may rank the different intersections according to a severity of the conflict factor associated with each intersection. Accordingly, the ranked list may serve as a recommended priority list for dispatching a limited pool of security or peace officers to the highest risk flock intersections first. Also, the ranked list may be used to ensure that a sufficient numbers of security or peace officers are dispatched to the intersections where they are most needed. In some embodiments, notification component 214 can specifically recommend where to dispatch officers and in what quantities based on the conflict factors.

In some embodiments, notification 490 may take any form practical to convey an alert, and information associated with the alert, to a user of system 200. In one non-limiting example, notification 490 may include a map, such as that shown in FIG. 3, which displays a representation of flocks 364A-B, flock travel paths 366A-B, and flock intersections 368 in a visual display. In such an example, notification 490 can configure the map, when intersection 368 is clicked on by a user, to display information, such as the associated conflict factor, on the intersection, and/or can configure the map, when flock 364A or 364B is clicked on by a user, to display information, such as characteristics and attributes, on the flock. In other non-limiting examples, notification 490 may be tailored to seamlessly integrate into a pre-existing security response system, appearing among other items in an interface used by the dispatcher. In still other non-limiting examples, notification 490 can appear as a popup or other alert on a mobile device carried by individual security or peace officers.

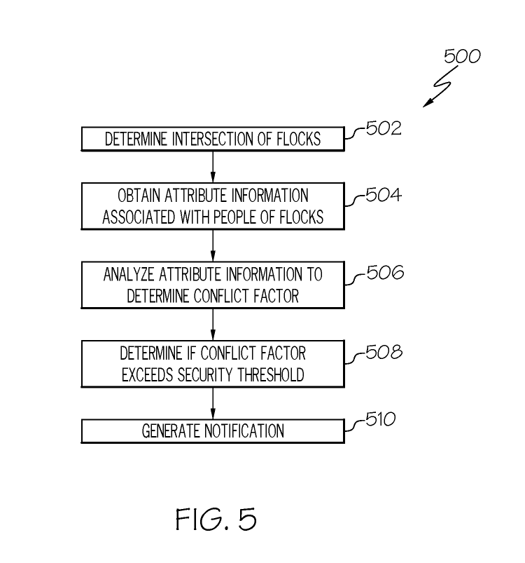

As depicted in FIG. 5, in one embodiment, a system (e.g., computer system/server 12) carries out the methodologies disclosed herein. Shown is a process flowchart 500 for predictive conflict identification in a safety response system. At 502, intersection prediction component 208 determines, based on a predicted travel vector 366A of a first flock 364A and a predicted travel vector 366B of a second flock 364B, an intersection location 368 of the first flock 364A and the second flock 364B. At 504, conflict researching component 210 obtains attribute information (e.g., 232, 234, 236, and 238) associated with people of the first flock 364A and people of the second flock 364B. At 506, conflict analysis component 212 analyzes the obtained attribute information to determine a conflict factor 484 between the first flock 364A and the second flock 364B. At 508, conflict analysis component 212 determines whether the conflict factor 484 exceeds a predetermined security threshold 486. At 510, notification component 214 selectively generates, responsive to a determination that the conflict factor 484 exceeds the predetermined security threshold 486, a notification 490.

Process flowchart 500 of FIG. 5 illustrates the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, program/utility 40 may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Any of the components provided herein can be deployed, managed, serviced, etc., by a service provider that offers to deploy or integrate computing infrastructure with respect to a process for predictive conflict identification in a safety response system. Thus, embodiments herein disclose a process for supporting computer infrastructure, comprising integrating, hosting, maintaining, and deploying computer-readable code into a computing system (e.g., computer system/server 12), wherein the code in combination with the computing system is capable of performing the functions described herein.

In another embodiment, the invention provides a method that performs the process steps of the invention on a subscription, advertising, and/or fee basis. That is, a service provider, such as a Solution Integrator, can offer to create, maintain, support, etc., a process for predictive conflict identification in a safety response system. In this case, the service provider can create, maintain, support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is apparent that there has been provided herein approaches for predictive conflict identification in a safety response system. While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

1. A method for predictive conflict identification in a safety response system, comprising:
determining, based on a predicted travel vector of a first flock and a predicted travel vector of a second flock, an intersection location of the first flock and the second flock;
obtaining attribute information associated with people of the first flock and people of the second flock;
analyzing the obtained attribute information to determine a conflict factor between the first flock and the second flock;
determining whether the conflict factor exceeds a predetermined security threshold; and
selectively generating, responsive to a determination that the conflict factor exceeds the predetermined security threshold, a notification.

2. The method of claim 1, the method further comprising:
analyzing a composition of a plurality of crowds of people using segmentation to determine shared attributes of a plurality of people in each crowd;
identifying, based on the determined shared attributes, the first flock and the second flock, each formed by one of the crowds of people, the first flock primarily consisting of people having a first shared attribute and the second flock primarily consisting of people having a second shared attribute; and
predicting the travel vector of the first flock and the travel vector of the second flock.

3. The method of claim 2, the analyzing a composition of a plurality of crowds further comprising obtaining information associated with the people of the plurality of crowds from at least one data source selected from the group consisting of: a security camera, a publicly available personal profile, and a database.

4. The method of claim 1, the analyzing the obtained attribute information to determine a conflict factor between the first flock and the second flock further comprising:
assigning a weight to a plurality of information items in the obtained attribute information;
aggregating the weights of the plurality of information items; and
assigning the intersection location of the first flock and the second flock a security rating based on the aggregation.

5. The method of claim 4, wherein the assigned weights are based on attribute severity thresholds pre-set by a user or automatically set based on historical data.

6. The method of claim 1, the predetermination of the security threshold being automated based on historical data.

7. The method of claim 1, the obtained attribute information comprising information selected from the group consisting of: publicly available information, recent news events, known history, and official records.

8. The method of claim 1, wherein the security threshold comprises a plurality of hieratical thresholds, each corresponding to a different, hieratical security authority, and wherein the method further comprises notifying a security authority corresponding to a hieratical threshold of the plurality of hieratical thresholds exceeded by the conflict factor.

9. A safety response computer system for predictive conflict identification, the computer system comprising:
a memory medium comprising program instructions;
a bus coupled to the memory medium; and
a processor, for executing the program instructions, coupled to a predictive conflict identification engine via the bus that when executing the program instructions causes the system to:
determine, based on a predicted travel vector of a first flock and a predicted travel vector of a second flock, an intersection location of the first flock and the second flock;
obtain attribute information associated with people of the first flock and people of the second flock;
analyze the obtained attribute information to determine a conflict factor between the first flock and the second flock;
determine whether the conflict factor exceeds a predetermined security threshold; and
selectively generate, responsive to a determination that the conflict factor exceeds the predetermined security threshold, a notification.

10. The computer system of claim 9, the instructions further causing the system to:
obtain information associated with people of a plurality of crowds from at least one data source selected from the group consisting of: a security camera, a publicly available personal profile, and a database;
analyze, based on the obtained information, a composition of the plurality of crowds of people using segmentation to determine shared attributes of a plurality of people in each crowd;
identify, based on the determined shared attributes, the first flock and the second flock, each formed by one of the crowds of people, the first flock primarily consisting of people having a first shared attribute and the second flock primarily consisting of people having a second shared attribute; and
predict the travel vector of the first flock and the travel vector of the second flock.

11. The computer system of claim 9, the instructions further causing the system to:
assign a weight to a plurality of information items in the obtained attribute information, the weight being based on attribute severity thresholds pre-set by a user or automatically set based on historical data;
aggregate the weights of the plurality of information items; and
assign the intersection location of the first flock and the second flock a security rating based on the aggregation.

12. The computer system of claim 9, wherein the predetermination of the security threshold is automated based on historical data.

13. The computer system of claim 9, wherein the obtained attribute information comprises information selected from the group consisting of: publicly available information, recent news events, known history, and official records.

14. The computer system of claim 9, wherein the security threshold comprises a plurality of hieratical thresholds, each corresponding to a different, hieratical security authority, and wherein the method further comprises notifying a security authority corresponding to a hieratical threshold of the plurality of hieratical thresholds exceeded by the conflict factor.

15. A computer program product for predictive conflict identification in a safety response system, the computer program product comprising a computer readable hardware storage device, and program instructions stored on the computer readable hardware storage device, to:
determine, based on a predicted travel vector of a first flock and a predictive travel vector of a second block, an intersection location of the first flock and the second flock;
obtain attribute information associated with people of the first flock and people of the second flock;
analyze the obtained attribute information to determine a conflict factor between the first flock and the second flock;
determine whether the conflict factor exceeds a predetermined security threshold; and
selectively generate, responsive to a determination that the conflict factor exceeds the predetermined security threshold, a notification.

16. The computer program product of claim 15, the computer readable storage device further comprising instructions to:
analyze a composition of a plurality of crowds of people using segmentation to determine shared attributes of a plurality of people in each crowd;
analyze, based on the obtained information, a composition of the plurality of crowds of people using segmentation to determine shared attributes of a plurality of people in each crowd;
identify, based on the determined shared attributes, the first flock and the second flock, each formed by one of the crowds of people, the first flock primarily consisting of people having a first shared attribute and the second flock primarily consisting of people having a second shared attribute; and
predict the travel vector of the first flock and the travel vector of the second flock.

17. The computer program product of claim 16, the computer readable storage device further comprising instructions to obtain information associated with the people of the plurality of crowds from at least one data source selected from the group consisting of: a security camera, a publicly available personal profile, and a database.

18. The computer program product of claim 15, the computer readable storage device further comprising instructions to:
assign a weight to a plurality of information items in the obtained attribute information;
aggregate the weights of the plurality of information items; and
assign the intersection location of the first flock and the second flock a security rating based on the aggregation.

19. The computer program product of claim 18, wherein the assigned weights are based on attribute severity thresholds pre-set by a user or automatically set based on historical data.

20. The computer program product of claim 15, wherein the predetermination of the security threshold is automated based on historical data.
